(19) United States
(12) Patent Application Publication
(10) Pub. No.: US 2016/0300165 A1
(43) Pub. Date: Oct. 13, 2016

(54) METHOD AND SYSTEM FOR PROCESS EVALUATION AND IMPROVEMENT USING VALUE AND RISK STREAM MAPPING (VRSM)

(71) Applicant: Vladimir Chevtchenko, Oakville (CA)

(72) Inventor: Vladimir Chevtchenko, Oakville (CA)

(21) Appl. No.: 14/684,339

(22) Filed: Apr. 11, 2015

(51) Int. Cl. G06Q 10/06

(52) U.S. Cl. CPC G06Q 10/0635; G06Q 10/06315; G06Q 10/06316

(57) ABSTRACT

A method of evaluation and improvement for a process, using estimates of process value-added (VA) and non-value added (NVA) time attributes, in conjunction with risks for customer as to requirements of expected product Quantity, Quality and Delivery. Estimated risks are used to correct timing attributes determined at values mapping step. The method also implements risk reduction steps aimed at detecting the operation with the largest risk within all process operations, so as to target such operation for improvement action.

### BACKGROUND OF THE INVENTION

The present invention relates generally to the field of process control and improvement and in particular to methods and tools for Lean Manufacturing and Service. As such, the present invention is equally applicable, without limitation, to manufacturing processes, service processes and product development processes.

Various methods of process control and improvement are known in the prior art, the most common of which are shown in FIG. 1 in Table 1. Some of these known methods belong to traditional Quality Assurance (PFMEA), some belong to Risk, Reliability and Safety Analysis and Improvement methods (HAZOP, RA), and others are members of Lean Manufacturing group (VSM and Modified VSM). They have their advantages and limitations in context of the subject matter of this invention (Value and Risk).

The prior art lacks a method that integrates Value Stream Mapping techniques with Risk estimation for all process operations; such a method and system would be desirable, as it would alleviate some of the limitations inherent in the referenced known methods.

### BRIEF DESCRIPTION OF INVENTION

The present disclosure recognizes and addresses the foregoing need for improved methods and systems for process evaluation, control and improvement. The present invention introduces a novel such method, named Value and Risk Stream Mapping (VRSM). According to a preferred embodiment, the VRSM method uses estimates of process value-added (VA) and non-value added (NVA) time attributes, along with and in conjunction with risks for customer as to requirements of expected product Quantity, Quality and Delivery. Estimated risks are used to correct timing attributes determined at values mapping step.

In a preferred embodiment, the VRSM method detects particular operations, which are the biggest contributors to overall risk; such risk breakdown allows to address specific corrective action to detected highest-risk process operations (“bottle necks”) and as a result, to improve a process. In various embodiments, the VRSM method is applicable to many Manufacturing processes, Service processes and Product Development processes. In a preferred embodiment, the VRSM method is implemented on a computer system, preferably by the use of custom software; alternative embodiments are also capable of being implemented by adapting existing commercial software, or even in semi-manual and manual modes.

### BRIEF DESCRIPTION OF THE DRAWINGS

The novel features which are believed to be characteristic of the method according to the present invention, as to its steps, organization, use and method of operation, together with further objectives and advantages thereof, will be better understood from the following drawings in which several preferred embodiments of the invention will now be illustrated by way of examples. It is expressly understood, however, that the drawings are for the purpose of illustration and description only, and are not intended as a definition of the limits of the invention. In the accompanying drawings:

FIG. 1 is a table of known, Prior Art methods of process control and improvement.

FIG. 2 is a Diagram depicting the overall Risk for customer, comprising risks to Quality, Quantity and Delivery.

FIG. 3 is a Diagram depicting the subcategories of risk within Risk for Quantity.

FIG. 4 is a Diagram depicting the subcategories of risk within Risk for Quality.

FIG. 5 is a Diagram depicting the subcategories of risk within Risk for Delivery.

FIG. 6 is a logical block Diagram for a preferred method of the invention herein, showing 3 stages and various steps.

FIG. 7 is the process map of the manufacturing process described in Example 1 herein.

FIG. 8 is the process map of the manufacturing process described in Example 1 herein, with added estimates of VA time, NVA time, lead time, quantity per shift/day/month.

FIG. 9 is a risk matrix of the manufacturing process described in Example 1 herein.

FIG. 10 is a tabulation of estimated risks for subgroups and a calculated overall estimated risk for Example 1 herein.

FIG. 11 is a Pareto chart of major risk components for Example 1 herein.

FIG. 12 is a Pareto chart of risk components within the biggest subgroup risk contributor for Example 1 herein. Abbreviation W/H means “warehouse”.

FIG. 13 shows the use of Pareto charts to determine the largest risk that must be addressed, in Example 1 herein.

FIG. 14 is the process map of a pizza making process described in Example 2 herein.

FIG. 15 is the process map of a pizza making process described in Example 2 herein, with added estimates of VA time, NVA time, lead time, quantity per shift/day/month.

FIG. 16 is the risk matrix showing risks as to Quantity, Quality and Delivery, for Example 2 herein.

FIG. 17 is a tabulation of estimated risks for subgroups and a calculated overall estimated risk for Example 2 herein.

FIG. 18 is a Pareto chart of major risk components for Example 2 herein.

FIG. 19 is a Pareto chart of risk components within the biggest subgroup risk contributor for Example 2 herein.

FIG. 20 shows the use of Pareto charts to determine the largest risk that must be addressed in Example 2 herein.

FIG. 21 is a Pareto chart for the Risk of Non-conformance for Example 2 herein.

FIG. 22 is the process map of a hospital emergency room/registration, triage and emergency treatment process described in Example 3 herein

FIG. 23 is the process map of a hospital emergency room/registration, triage and emergency treatment process described in Example 3 herein, with added estimates of VA time, NVA time, lead time, quantity per shift/day/month.

FIG. 24 is the risk matrix showing risks as to Quantity, Quality and Delivery, for Example 3 herein.

FIG. 25 is a Pareto chart of major risk components for Example 3 herein.

FIG. 26 is a Pareto chart of risk components within the biggest subgroup risk contributor for Example 3 herein.

FIG. 27 is the process map of the manufacturing process in Example 4 herein, consisting of the following stages: Inspection, Turning, Drilling/Milling, Grinding, Deburring, Packaging and Final inspection.

FIG. 28 is the process map of the manufacturing process in Example 4 herein, with added estimates of VA time, NVA time, lead time, quantity per shift/day/month.

FIG. 29 is the risk matrix showing risks as to Quantity, Quality and Delivery, for Example 4 herein.

FIG. 30 is the risk matrix with estimated individual risks and calculated overall risk for subgroups, for Example 4 herein.

FIG. 31 is a table with Actual Quantities calculated using the total estimated risk, for Example 4 herein.

FIG. 32 is a Pareto chart of major risk components for Example 4 herein.

FIG. 33 is a Pareto chart of risk components within the biggest subgroup risk contributor for Example 4 herein.

FIG. 34 is a series of Pareto charts of major risk components for Example 4 herein, showing the impact of Risk elimination of a former biggest risk contributor.

FIG. 35 is a Pareto chart of risk components within the current biggest subgroup risk contributor for Example 4 herein.

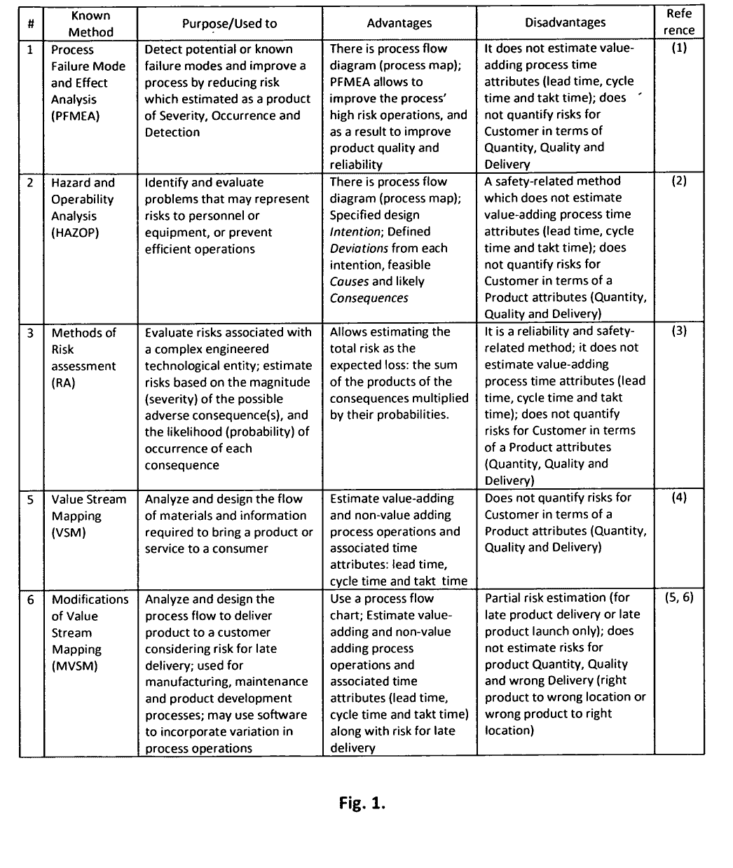

### DETAILED DESCRIPTION OF A PREFERRED EMBODIMENT OF THE INVENTION

For a better understanding of this invention, some introductory concepts will be introduced first, in the context of a manufacturing process (production plant).

Value for Customer.

Ideally, all materials are delivered to a production plant with no delay, go straight into the manufacturing process, and then move smoothly through all of the stages of the process until the product is complete. The correctly identified and only in-spec (Quality) finished products of customer-required Quantity are delivered to Customer-specified location and without delay (Delivery). Product Price is out of scope of this method; therefore, the formula for Customer Value is

Customer Value=Quantity+Quality+Delivery

Actual value is smaller than ideal value due to existing risks for Quantity, Quality and Delivery; this invention focuses on these three components of Customer Value at a process level in terms of associated risks, either actual risks for existing processes or potential risks for new processes.

Risk for Customer.

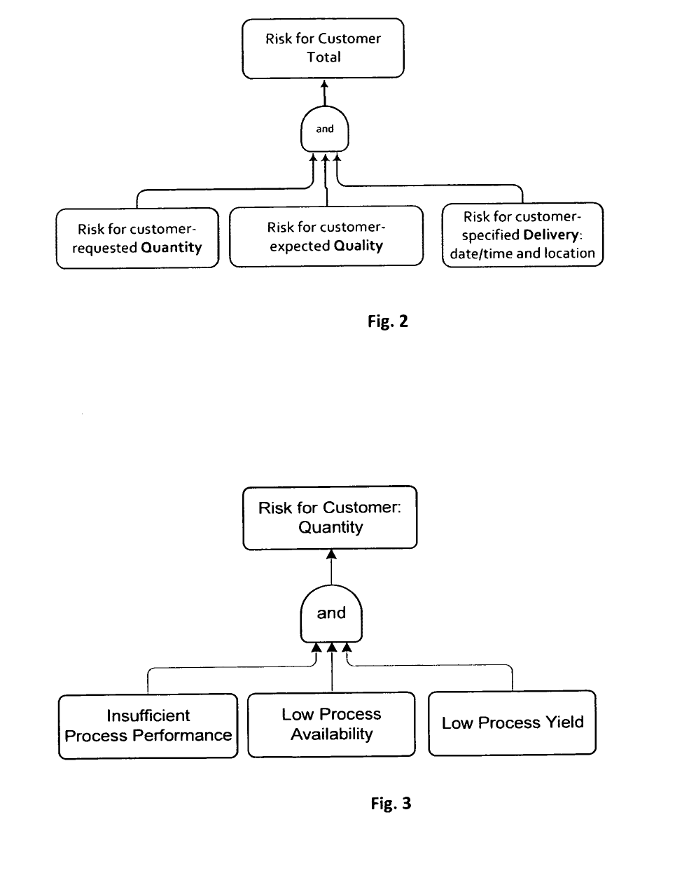

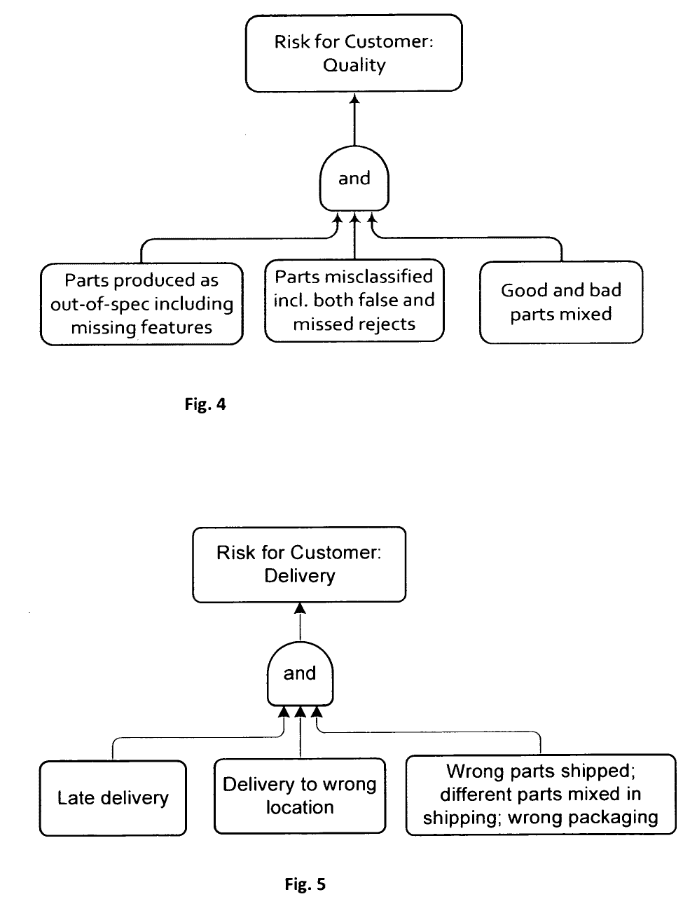

Risk for Customer is defined as a probability to have a lack of or no expected value e.g. poor Quality, insufficient Quantity and not-in-time or wrong-place Delivery, as shown in FIGS. 2-5.

The Method of this Invention.

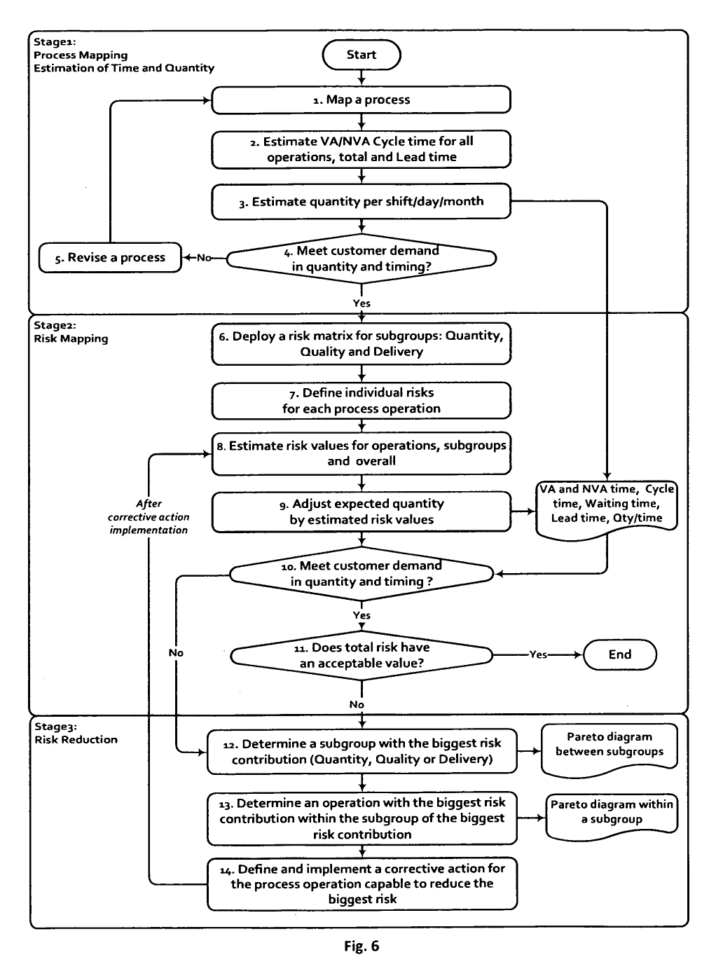

The method described herein includes three stages, as depicted in FIG. 6, namely Value Stream Mapping, Risk Mapping and Risk Reduction. Value Stream Mapping is applied to estimate process time attributes and expected Quantity; Risk Mapping is applied to estimate risks for Quantity, Quality and Delivery. Risk Reduction is used to determine the biggest risk contributor, to know where to apply an improvement action.

### Risks and Risk Estimation.

Individual Operation Risks:

Risks for particular process operations are estimated by using recent or historical data collected for non-conformances, downtime, rejects, etc. for each particular process operation; for example for an assembly operation (as discussed in the example 1 below): % rejects due to assembly non-conformances, % of machine downtime; for an inspection or testing operation: % misclassified parts (false accepts and false rejects); % damage in inspection area, % mixed parts (accepted and rejected together) at inspection station.

Accumulated Risks within Subgroups of Quality, Quantity and Delivery:

Assuming that events associated with risks for Quantity, Quality and Delivery are independent but not mutually exclusive, the most suitable formula for estimation of resulting risk within subgroups and between subgroups is:
For three operations (Op1, Op2 and Op3) in a process (as an simplified example):

P(Op1 or Op2 or Op3)=P(Op1)+P(Op2)+P(Op3)−P(Op1)*P(Op2)*P(Op3)
For N operations in a process in general (the symbol U means “or”, the symbol Σ means “a sum” and the symbol Π means “a product”):

$$P {{⋃}_{1}}^{N} Op = {\sum }_{1}^{N} Op + {\prod }_{1}^{N} Op$$

Accordingly an overall risk accumulated for all three subgroups:

P(Quantity or Quality or Delivery)=P(Quantity)+P(Quality)+P(Delivery)−P(Quantity)*P(Quality)*P(Delivery)

Practical Considerations:

a. If at least one of individual operation risks is equal to zero then entire product becomes Π₁^{N}Op=0; as to subgroups, they individually are rarely equal to zero, therefore product component to overall risk almost always exists;
b. Small values of individual operation risks make the product Π₁^{N}Op≈0; then cumulative risks for subgroups become practically equal to P∩₁^{N}Op≈Σ₁^{N}Op.

### DESCRIPTION OF THE INVENTION

As envisaged herein, Value and Risk Stream Mapping (VRSM) is a process evaluation and analysis method aimed to improve the process, to meet customer requirements, specifically in Quantity of product or service, Quality of product or service and in Delivery of product or service including in-time and in-right-location delivery.

In a preferred embodiment, the VRSM technique includes three major stages: Process Mapping, Risk Mapping, and Risk Reduction. Process Mapping is where process time attributes are estimated and quantity of product or service are evaluated. Risk Mapping is where risk values are estimated for all process operations, and a sum of these operational risks is an estimate of overall Risk for Customer; estimated risks are combined in the following three groups: Risk for Quantity, Risk for Quality, and Risk for Delivery. Risk Reduction is the 3^{rd} stage, aimed at detecting an operation with the largest risk within all process operations in order to address an improvement action.

These three techniques are used sequentially, jointly and in interaction (as shown in FIG. 6); results of Process Mapping are used for Risk Mapping; Risk Reduction utilizes results of Risk Mapping. Also, outputs of Risk Reduction are used by Risk Mapping to adjust values of risk after process improvement; results of Risk Mapping are applied to Process Mapping to amend quantity of production as to estimated risks; for example, total Risk for Quantity, Quality and Delivery is used to amend expected quantity of parts estimated as Process Mapping.

### DETAILED DESCRIPTION OF THE METHOD ACCORDING TO A PREFERRED EMBODIMENT

VRSM method is a technique which includes the following three stages: Stage 1: Process Mapping/Estimation of Time and Quantity; Stage 2: Risk Mapping; and Stage 3: Risk Reduction (as depicted in FIG. 6).

Stage 1. Process Mapping/Estimation of Time and Quantity includes process mapping and estimation of process value-added (VA) time and non-value added (NVA) time, lead time, WIP time, and expected Quantity of parts or service to be delivered per unit of time.

Stage 2. Risk Mapping includes estimation of risks for customer at particular process operations as to expected product Quantity, Quality and Delivery and then estimation of overall risk. Risk values are estimated on the basis of existing and historical data of process-related failure rates, process availability data, machine downtime; delays of product delivery; probability of misclassification due to inaccuracy of end-of-the-line testing machine or inspection miss rate, etc. These estimated risks are used to make adjustments to quantity of parts or service to be delivered per unit of time (back in stage 1, as depicted in FIG. 6).

Taking risks into consideration makes estimation of expected quantity of parts/service more accurate and allows arranging sufficient resources to meet customer demand, e.g. to reserve additional resources to make extra parts to compensate lack of delivery and non-conformant parts or services.

Stage 3. Risk Reduction is effected after detecting which process operations are the biggest contributors to overall risk; such risk analysis allows to address specific improvement action to those highest-risk process operations (“bottle necks”) detected and, as a result, to improve a process in terms of meeting customer's expectations in Quantity, Quality and Delivery for products or service.

Stages 1-3 of this method may be replicated and applied repeatedly to the same process, until the process meets customer demand in quality, quantity and delivery, and until total risk becomes insignificant and/or further improvement actions are not cost effective.

A better understanding as to this method's functionality, applicability and benefits can be derived from the following four examples, which are not, in any way, limiting as to the scope of this invention.

### Example 1

### Manufacturing Process (Simplified)

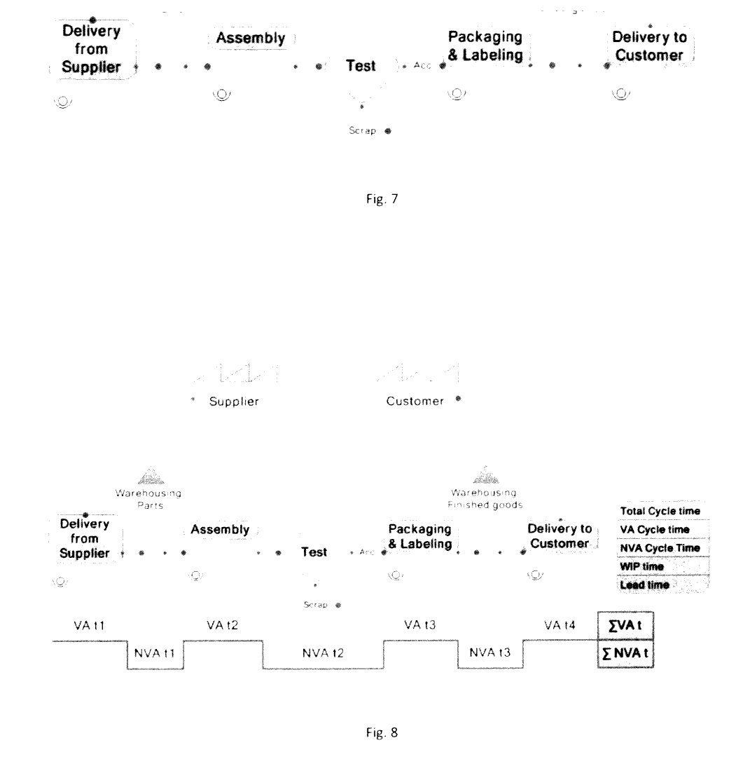

As depicted in FIG. 7, Step 1 (of Stage 1) of the method consists of making a process map of the selected manufacturing process.

As depicted in FIG. 8, Steps 2 and 3 (of Stage 1) consist of estimating VA time, NVA time, lead time, and quantity per shift/day/month.

Assuming an estimated Total Cycle time=VA Cycle time+NVA Cycle time=120 sec and an actual Lead time=25,200 sec (7 hours shift), then expected quantity is 25,200/120=210 parts. If customer demand is 190 units per shift, the process meets requirements without estimation of risks; therefore, step 5 is not needed in this particular example.

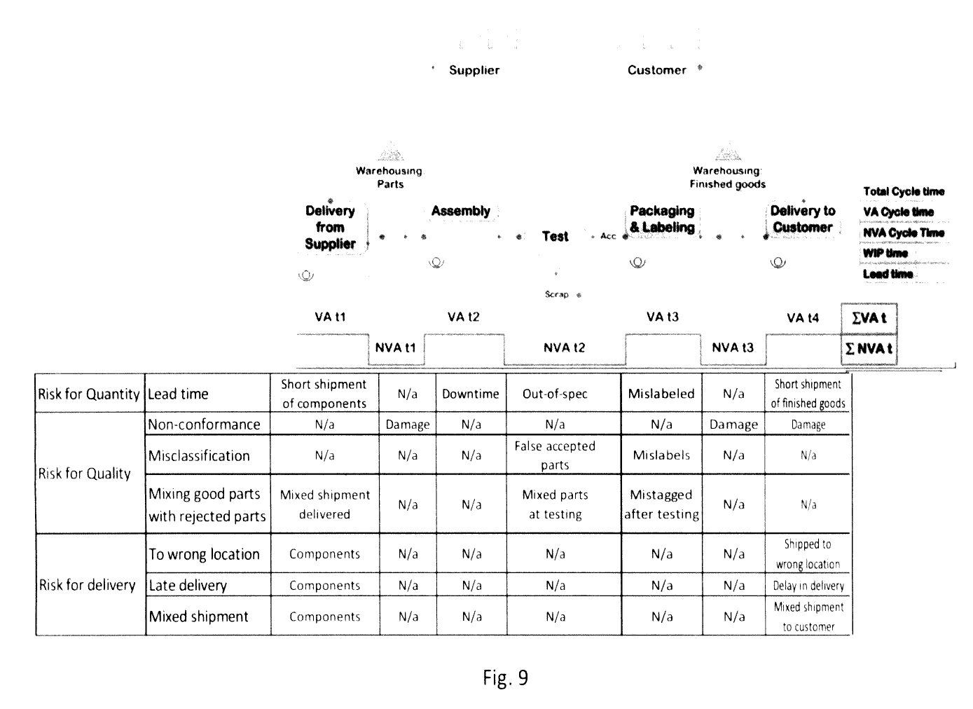

Moving on to Stage 2, the Steps 6 and 7 involve deploying a risk matrix and defining risks for subgroups: Quantity, Quality and Delivery, as depicted in FIG. 9.

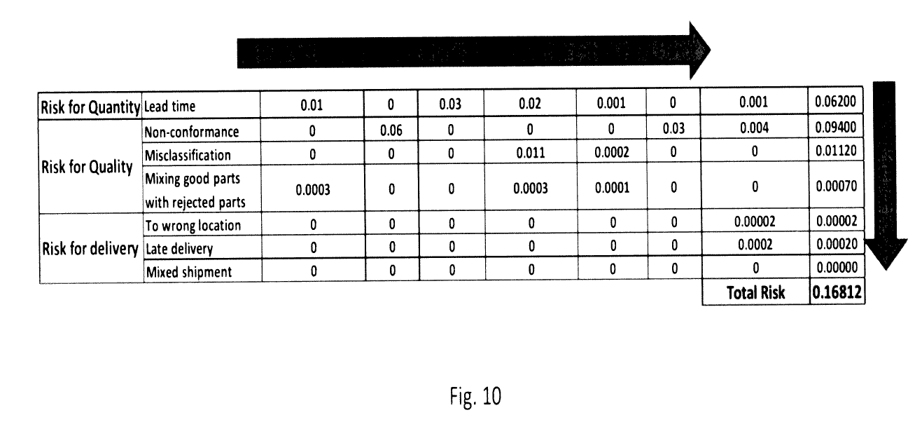

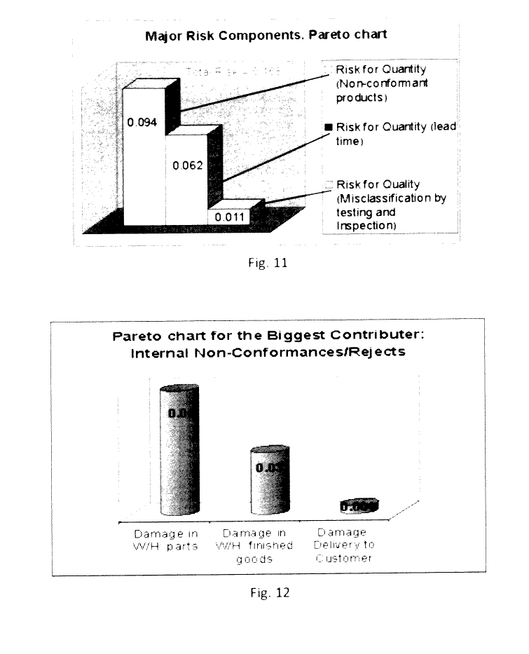

In Stage 2, Step 8 (as depicted in FIG. 10): Estimate individual risks of particular process operations, by using historical data, audit results, customer complaints data, etc. Estimate overall risk for subgroups (Risk for Quantity, for Quality and for Delivery) as a sum of risks. Then estimate overall risk as a sum of risks for all three subgroups (in this example=0.16833).

In Stage 2, Steps 9 and 10: Adjust time and/or expected quantity by estimated risk values:

Adjusted Quantity=Estimated Quantity (1−Total Risk)=210*(1−0.16833)=210*0.83167=174.6 or 174 as a truncated value.

Accordingly, the value of expected quantity of produced finished goods considering risks is 174, which is smaller than customer demanded value of 190.

In Stage 3, Step 12: determine a subgroup of the biggest risk contribution (Risk for Quantity, Risk for Quality and Risk for Delivery) by using a Pareto chart, as depicted in FIG. 11.

In Stage 3, Step 13: Determine an operation with the biggest risk contribution within the biggest subgroup risk contributor by using a Pareto chart, as depicted in FIG. 12, where the abbreviation W/H means “warehouse”.

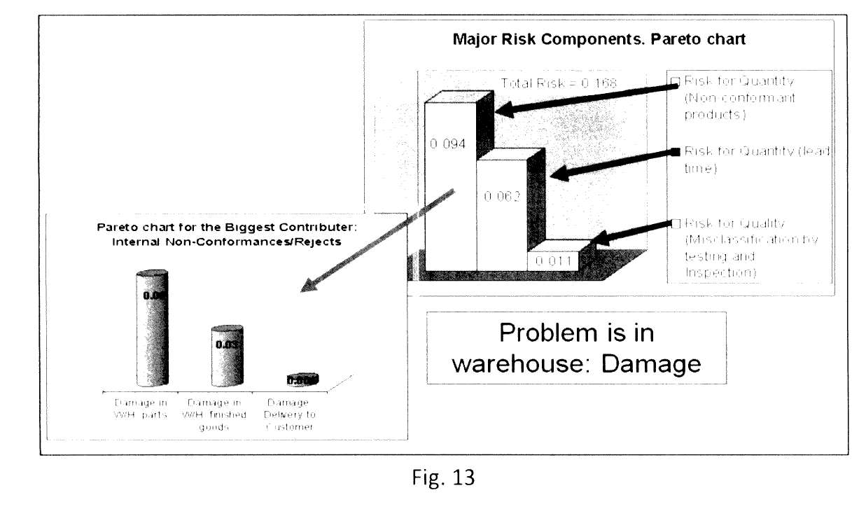

In Stage 3, Step 14: Determine and implement an improvement action for the process operation capable to reduce the largest risk, as depicted in FIG. 13.

This Risk estimation cycle should be repeated after each improvement action implementation (step 8 of Stage 2), ending up the process iterations when the total risk has been reduced to acceptable level, or when further improvement actions become cost ineffective.

For this example, implementation of improvement actions in warehouse focused on elimination of damage issues (work instruction for forklift drivers and material handlers, extra training, better lighting, new skids, etc.). Assuming that the Risk of damage has been reduced to zero, then a recalculated total risk is R=0.16833−0.094=0.07433. The recalculated total parts per shift becomes 210*(1−0.07433)=194.39 or 194 as a truncated value (which exceeds the expected number of parts/quantity=190).

Stage 2, Step 11: Occasionally, even a process which meets customer demand of Quantity and Delivery might show an unacceptably large value for “Risk for Quality”; in those circumstances, further improvement actions are needed.

### Example 2

### Pizzeria: Order Taking, Pizza Making and Delivery

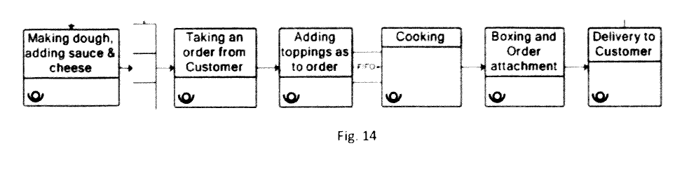

Stage 1, Step 1: a typical process map for the pizza order taking, making and delivery process is shown in FIG. 14.

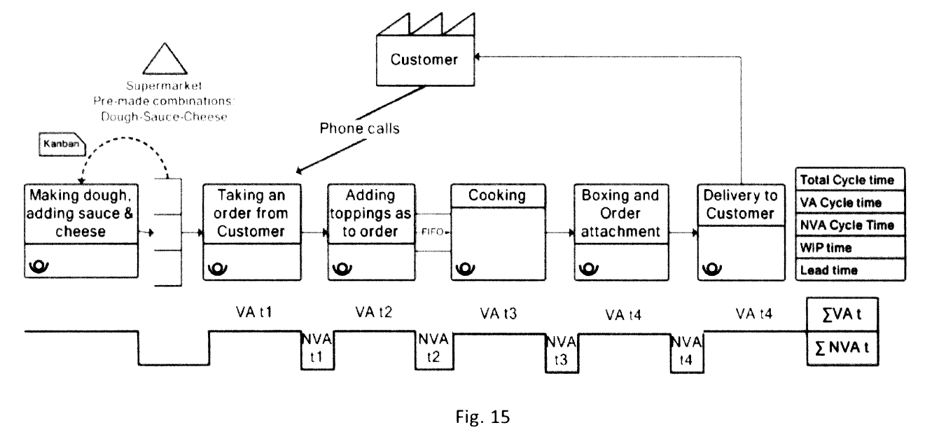

Stage 1, Steps 2 and 3: estimate VA time, NVA time, lead time, quantity per shift/day/month, as shown in FIG. 15. Assume estimated Lead time=VA time+NVA time=1080 sec (18 min) and actual shift time=43,200 sec (12 hrs shift), then quantity of pizza deliveries is 40 without estimation of risk values. If expected quantity/forecast for this day/time of the week is 37 calls, then the process meets requirements; therefore, step 5 is not needed.

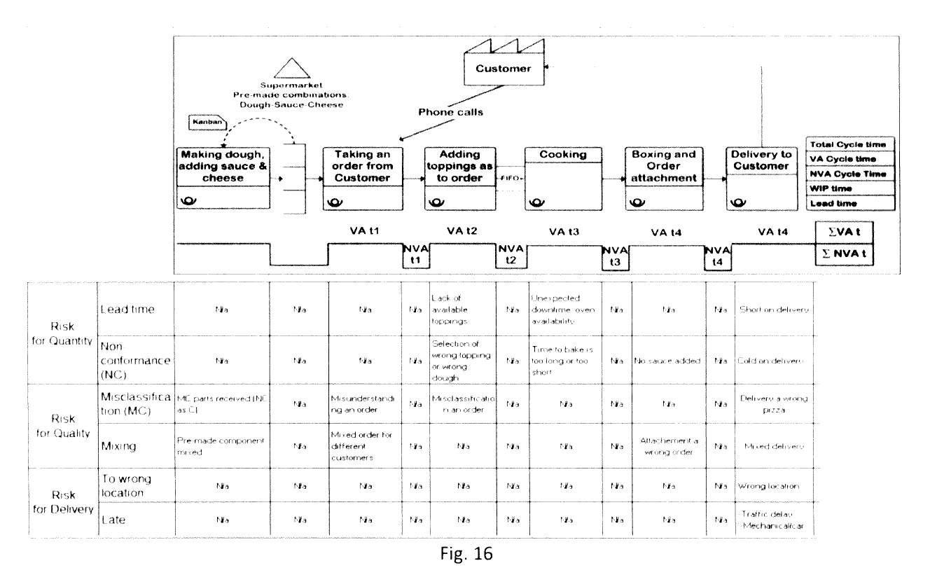

Stage 2, Steps 5 and 6: deploy a risk matrix and define risks as to Quantity, Quality and Delivery, as shown in FIG. 16.

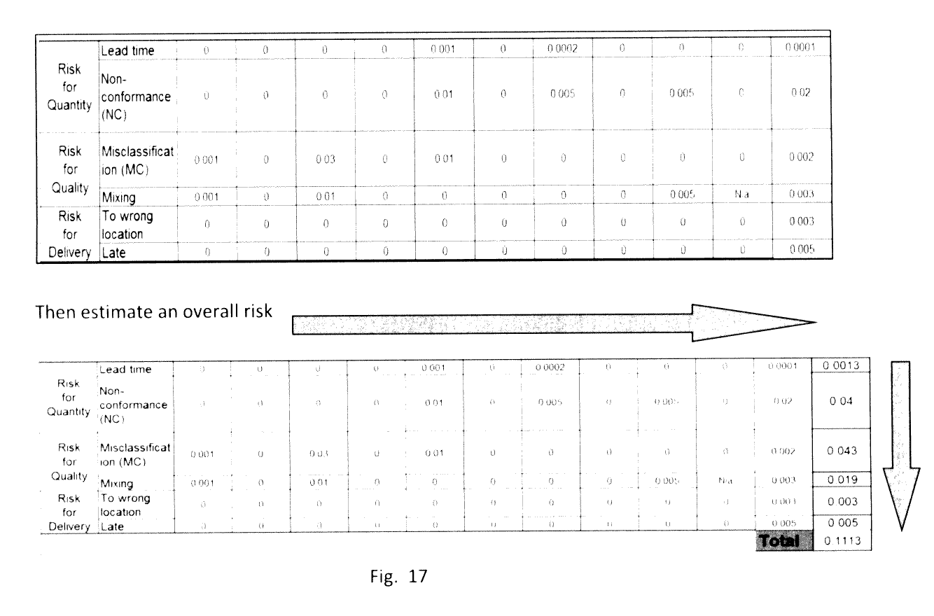

Stage 2, Step 8, as shown in FIG. 17: Estimate individual risks of particular process operations, use historical data, audit results, and customer complaints data. Estimate overall risk for subgroups (Risk for Quantity, Risk for Quality and Risk for Delivery) as a sum of risks assuming independent events within subgroups. Then estimate an overall risk.

Stage 2, Steps 9 and 10: Quantity=Estimated Quantity*(1−Total Risk)=40 (1−0.1113)=35.6 or 35 as a truncated value. So, quantity of pizza deliveries considering risks is 35, which is smaller than the 37 expected calls. In order to meet consumers' demand, pizzeria has to either:
take more orders, (for example, if 40 orders are taken instead on 37), the Quantity becomes=40+40*Risk=40+40*0.1113=44.52 or 45 (this proves that taking additional pizza orders serves as a risk compensation quantity); or
improve the process by determining the biggest risk contributor, followed by the implementation of a improvement action to minimize estimated risk; this option is more effective due to its waste-preventive nature.

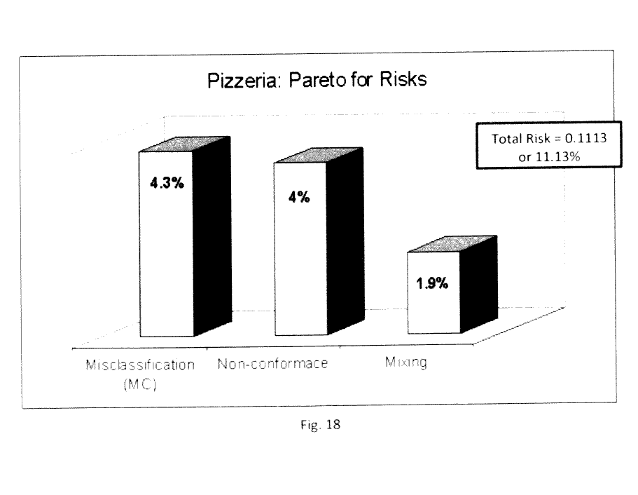

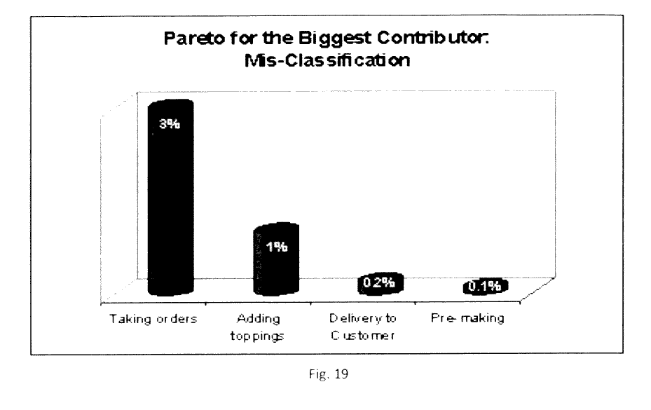

Stage 3, Step 12: determine a subgroup of the biggest risk contribution (Risk for Quantity, Risk for Quality and Risk for Delivery) by using a Pareto chart, as shown in FIG. 18. Total Risk is 0.1113 or 11.13%, and the biggest risk contributor is Risk for Quality/Misclassification 0.043 or 4.3%.

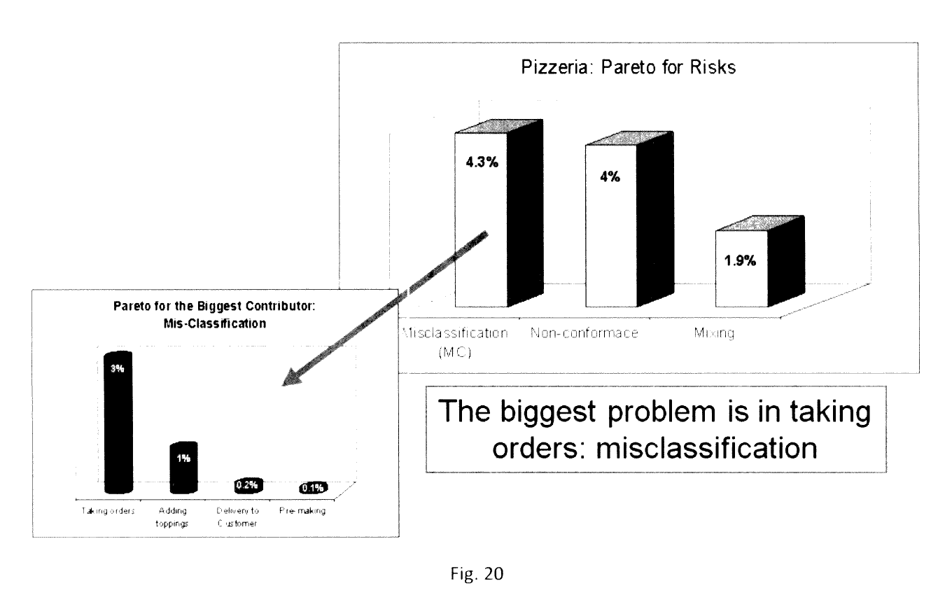

Stage 3, Step 13: Define biggest risk contributors within the biggest subgroup risk contributor (Risk for Quality in this case) by using a Pareto chart, as shown in FIG. 19. From the Pareto charts shown in FIGS. 19 and 20, it becomes obvious that it is Misclassification at the operation “Taking orders” (or, in other words, the error rate in taking orders by phone) that is the largest risk contributor, at 0.03 or 3%.

Stage 3, Step 14: Once the weakest link is found, then define and implement an improvement action for this operation to reduce the biggest risk. Such operation is “Taking orders” by phone with the risk of misclassification of pizza orders (errors in taking orders). Implementation of improvement actions focused on elimination of such errors (such as better selection of call takers, using work instruction, extra training, after-order confirmation calls) should be able to reduce such risk to zero. Recalculated total risk then becomes R=0.1113−0.03=0.0813. Then quantity per shift becomes 40*(1−0.0683)=36.7 or 36. Expected number of calls is 37, therefore now the process almost meets demand.

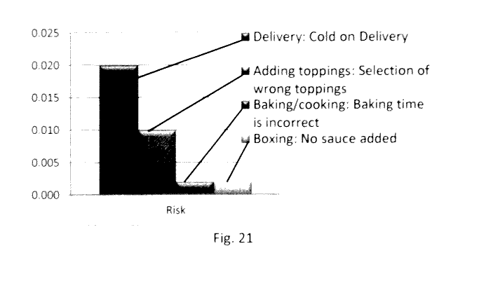

At the same time, the Risk of Non-conformance remains high, with the value of 0.04 or 4%. The biggest contributor to this 4% total is the operation of Delivery, with the largest contributor issue being “Cold on delivery”, with its individual risk value of 0.02 or 2%, as shown in FIG. 21. A further reduction of this risk by 1% would render the process capable to meet customer demand, because the newly calculated Residual risk would be re-calculated as =0.0813−0.01=0.0713. Quantity, with consideration for the new residual risk, becomes 7.13% is 40*(1−0.0713)=37.1 or 37 after rounding.

### Example 3

### Hospital Emergency Room/Registration, Triage and Emergency Treatment Process

For this process: Customers=patients; Customer defined value=health and life; Resources=beds, doctors, equipment, space, etc.

Customers' requirements as to:
Quantity: to receive sufficient diagnostic and medical resources adequate to existing severity;
Quality: a correct diagnosis and an appropriate, as to diagnosis and severity, medical treatment;
Delivery of service: just-in-time/no or minimal waiting time in registration, diagnostic and treatment.

Risks for patients:
Errors in registration/data entry causing delay or wrong treatment;
Errors in diagnostics causing incorrect treatment;
Errors in treatment causing more severe conditions or even death.

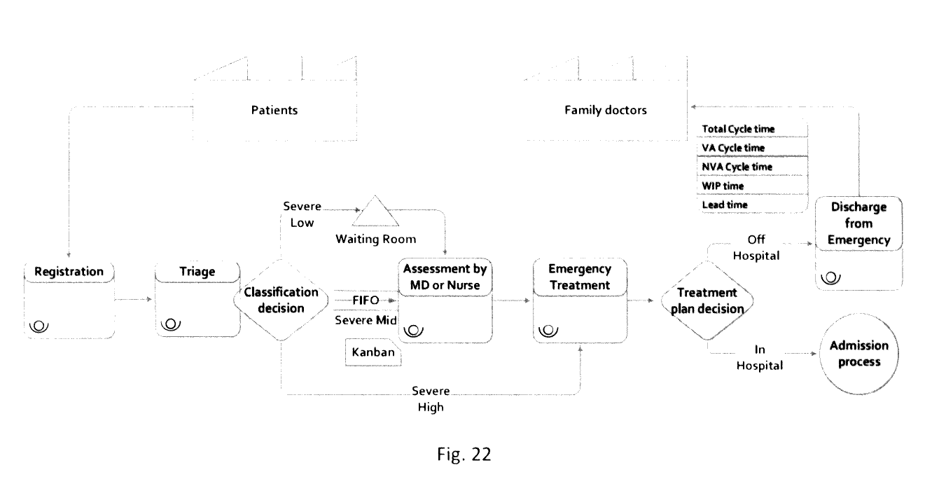

Stage 1, Step 1: a process map is drawn for the process, as shown in FIG. 22.

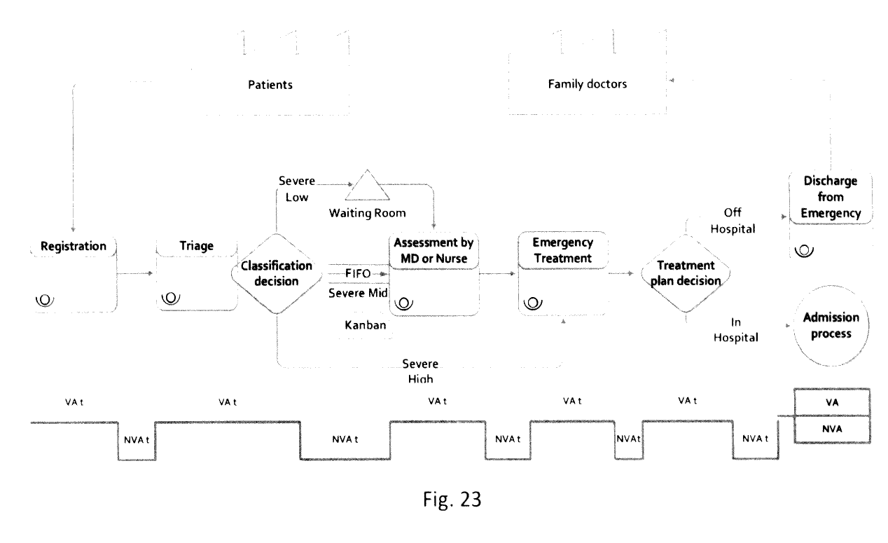

Stage 1, Steps 2 and 3: estimate VA time, NVA time, lead time, quantity per shift/day/month, as shown in FIG. 23. Assume estimated Lead time=VA time+NVA time=1080 sec (18 min) and actual time=86,400 sec (24 hrs), then quantity of served patients is 80 without taking into account an estimated process risk values. Expected quantity/forecast for this day/time is 75 patients, therefore the process meets requirements (no need for step 4), without taking into account existing risks.

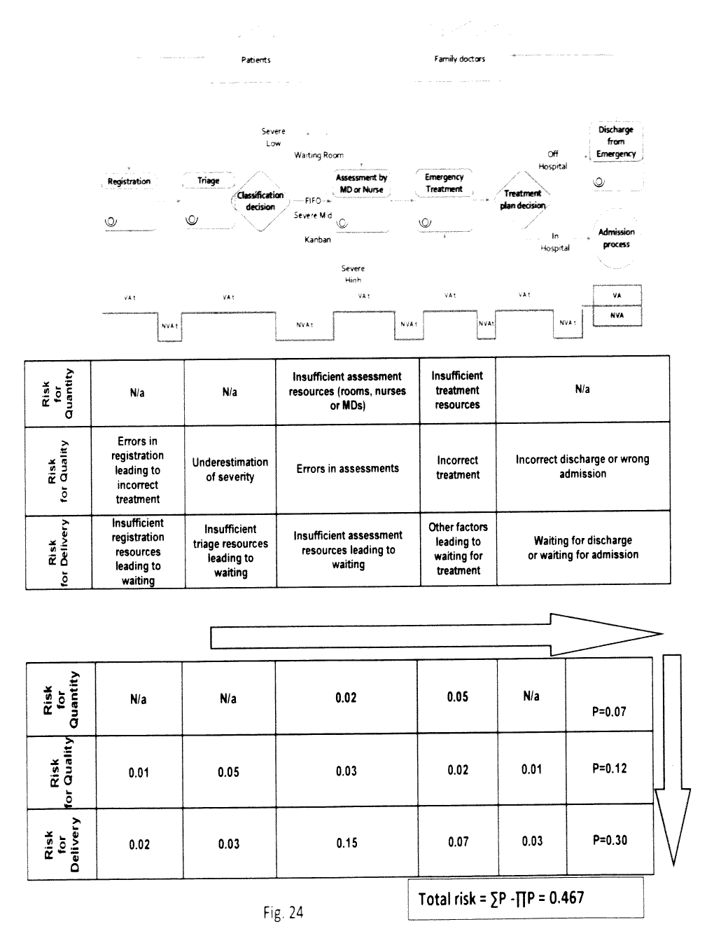

Stage 2, Steps 5 and 6: deploy a risk matrix and define risks as to Quantity, Quality and Delivery, as shown in the top two thirds of FIG. 24.

Stage 2, Step 8: Estimate risk values for operations, subgroups and overall risk, as shown in the bottom table in FIG. 24.

Stage 2, Steps 9 and 10: Quantity=Estimated Quantity (1−Total Risk)=80 (1−0.467)=42.6 or 42 after rounding. Accordingly, the number of treated patients, considering risks, is only 42, much smaller than the expected 75 needing treatment. In order to meet patient demand, the hospital will have to:
take more resources to meet patient demand with existing process risk value; or
improve the process by detection of the biggest risk contributor and implementation of a improvement action to minimize such risk; or
a combination of the above two.

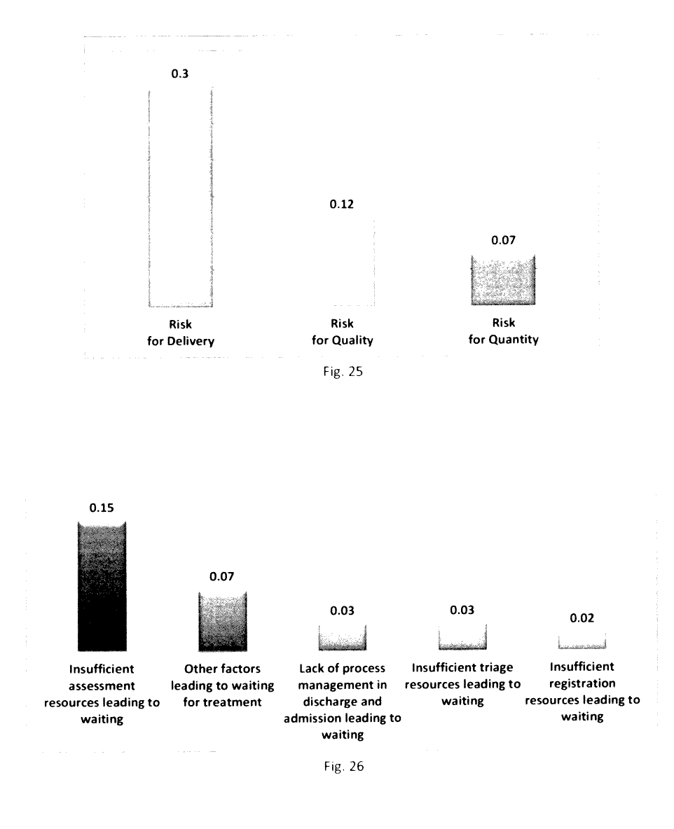

Stage 3, Step 12: define the biggest risk contributors between subgroups (Risk for Quantity, Risk for Quality and Risk for Delivery) by using data from the risk matrix, graphed on a Pareto chart, as shown in FIG. 25.

Stage 3, Step 13: Define biggest risk contributors within a biggest subgroup risk contributor (Risk for Delivery, in this case) by using a Pareto chart, as shown in FIG. 26, which depicts the risk contributors within the Risk for Delivery subgroup.

Stage 3, Step 14: determine and implement an improvement action for the process to reduce the biggest risk seen in the Pareto chart depicted in FIG. 26. It is apparent that the biggest risk contributor is the process operation “Assessment by MD and Nurse”, and the largest risk caused by “Insufficient assessment resources leading to waiting”; accordingly, this process operation should be selected as the subject of an appropriate improvement action.

Steps 8-11 of this method should be re-applied to the process after each upstream implementation of an improvement action; such method, analysis and improvements should be reiterated until the process meets the demand for quantity, and total risk reaches an acceptable level.

### Example 4

### Manufacturing Process (Production of Metallic Plate Housings for Automotive Plants)

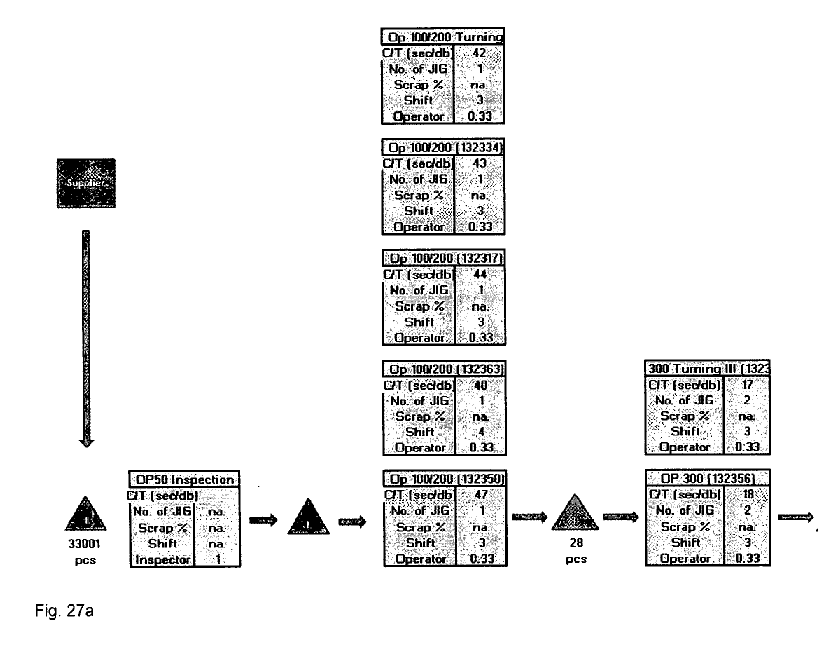

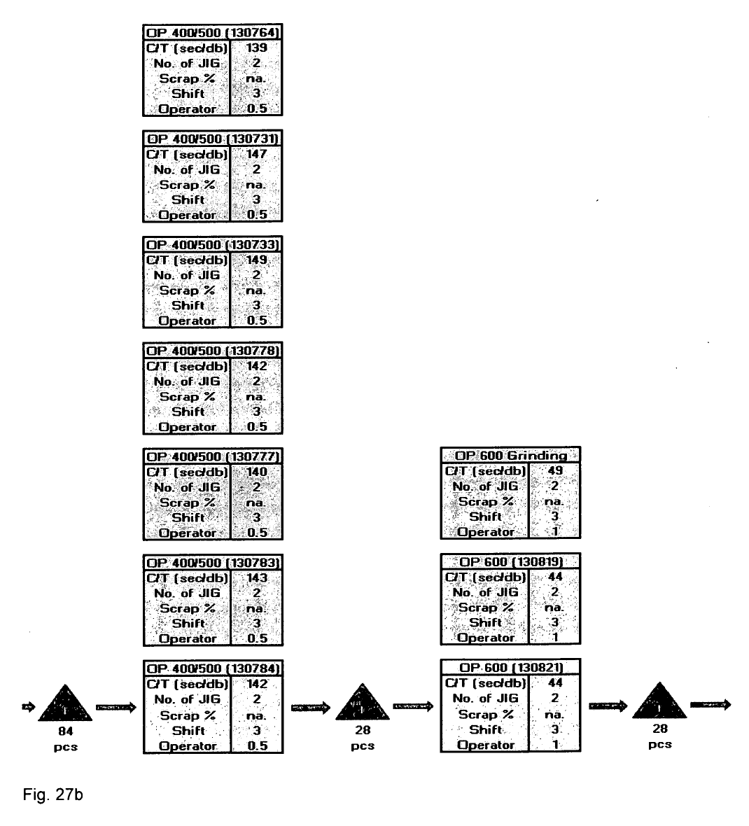

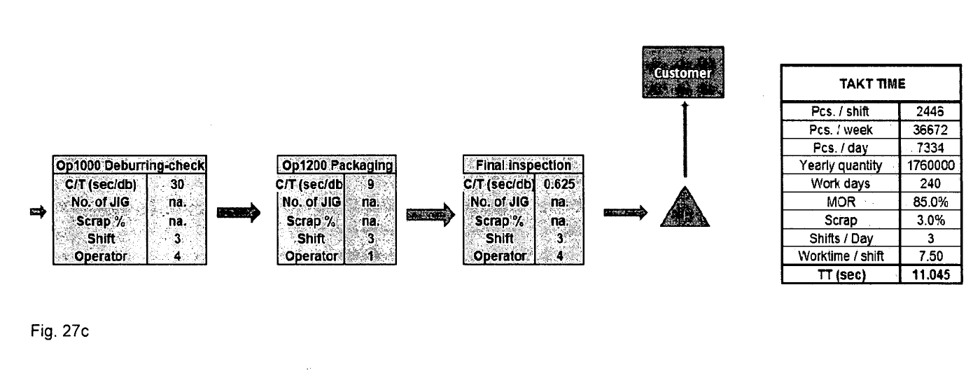

Stage 1, Step 1: FIG. 27 depicts the process map of a manufacturing process consisting of the following stages: Inspection, Turning, Drilling/Milling, Grinding, Deburring, Packaging and Final inspection.

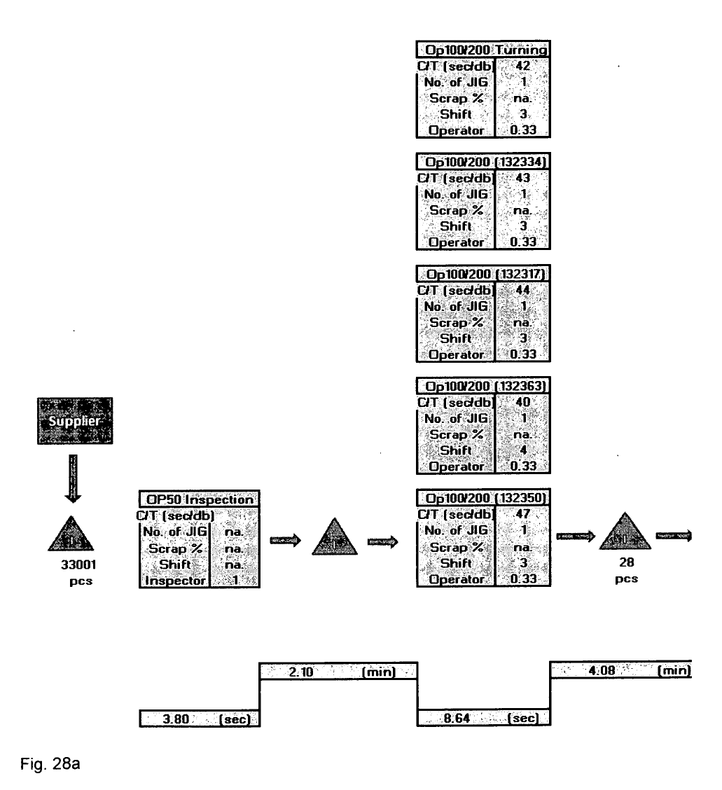

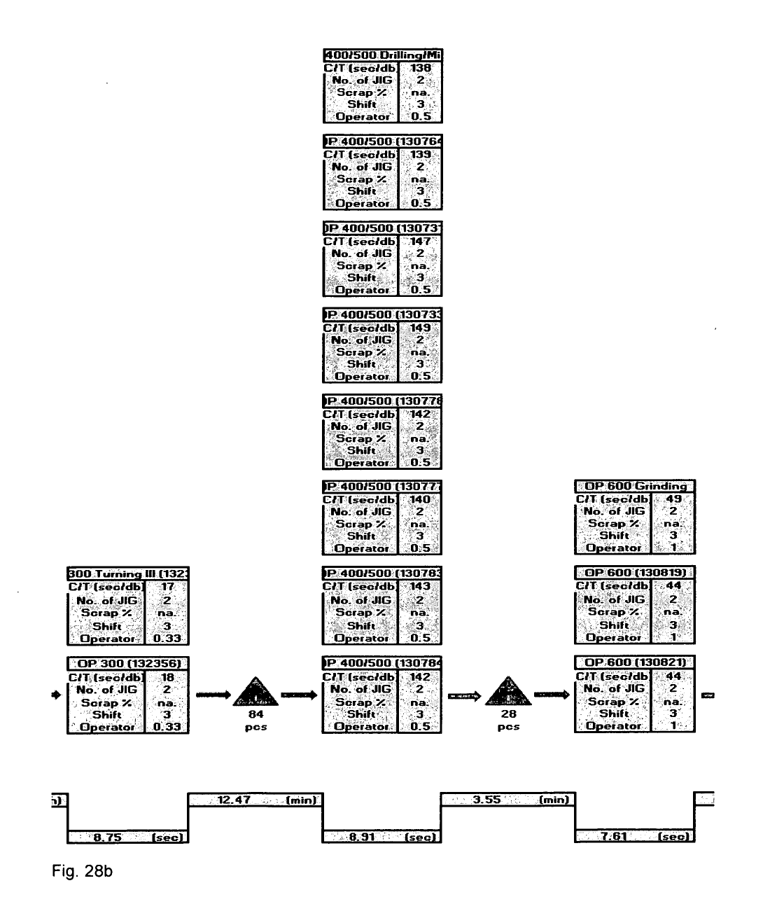

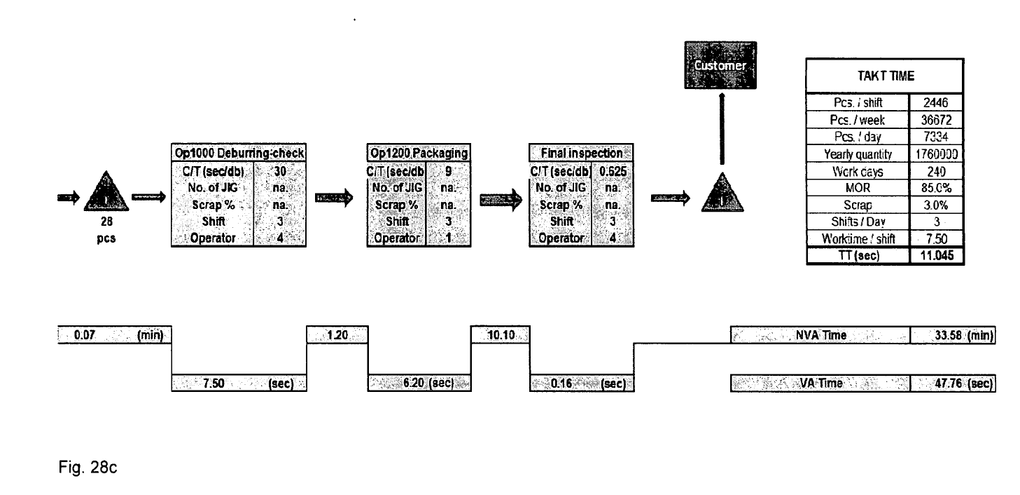

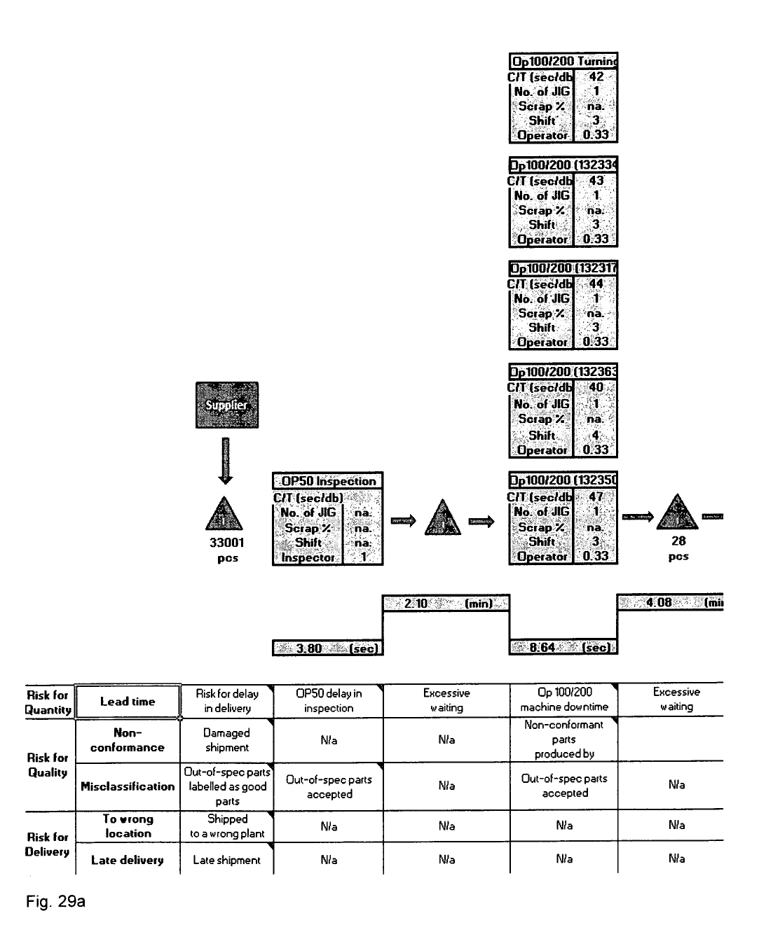

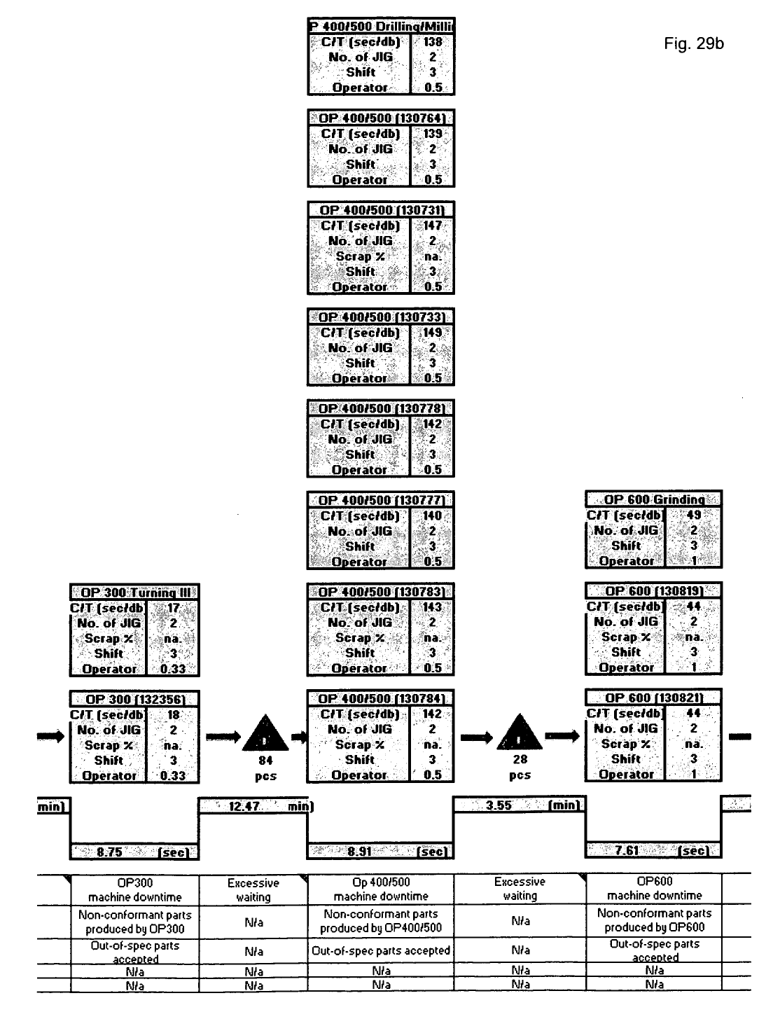

Stage 1, Step 2 and 3: estimate VA time, NVA time, lead time, quantity per shift/day/month, and graph them, as shown in FIG. 28.

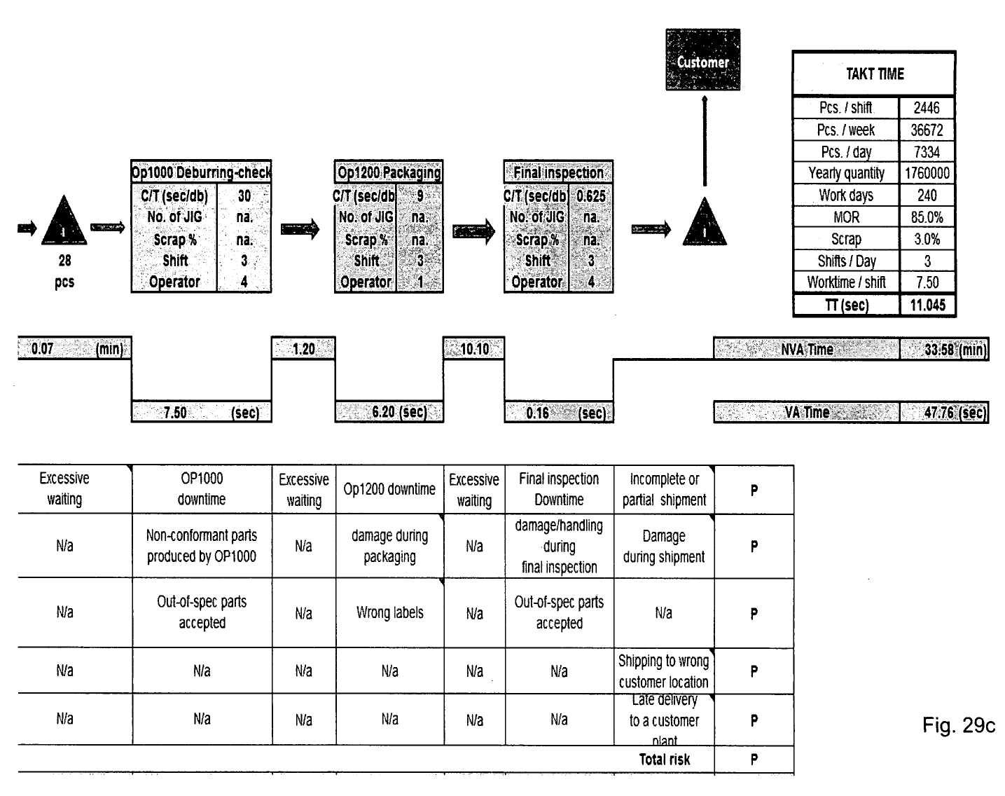

Stage 2, Steps 5 and 6: deploy a risk matrix and define risks as to Quantity, Quality and Delivery, as shown in FIG. 29.

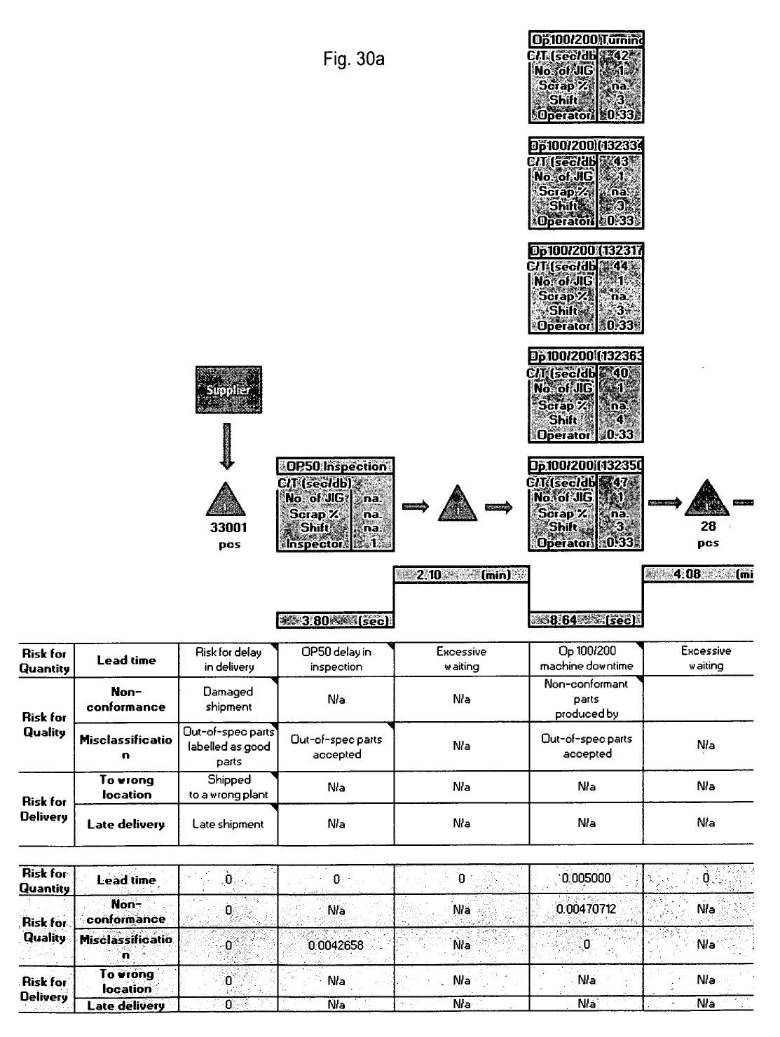

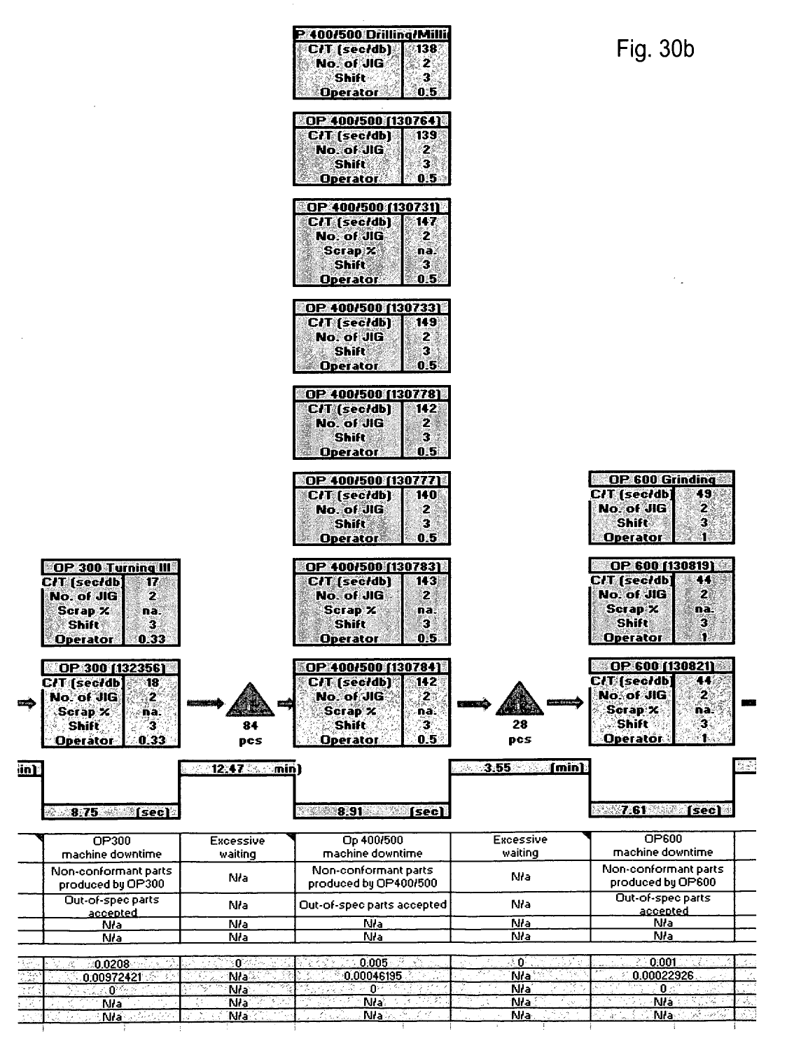

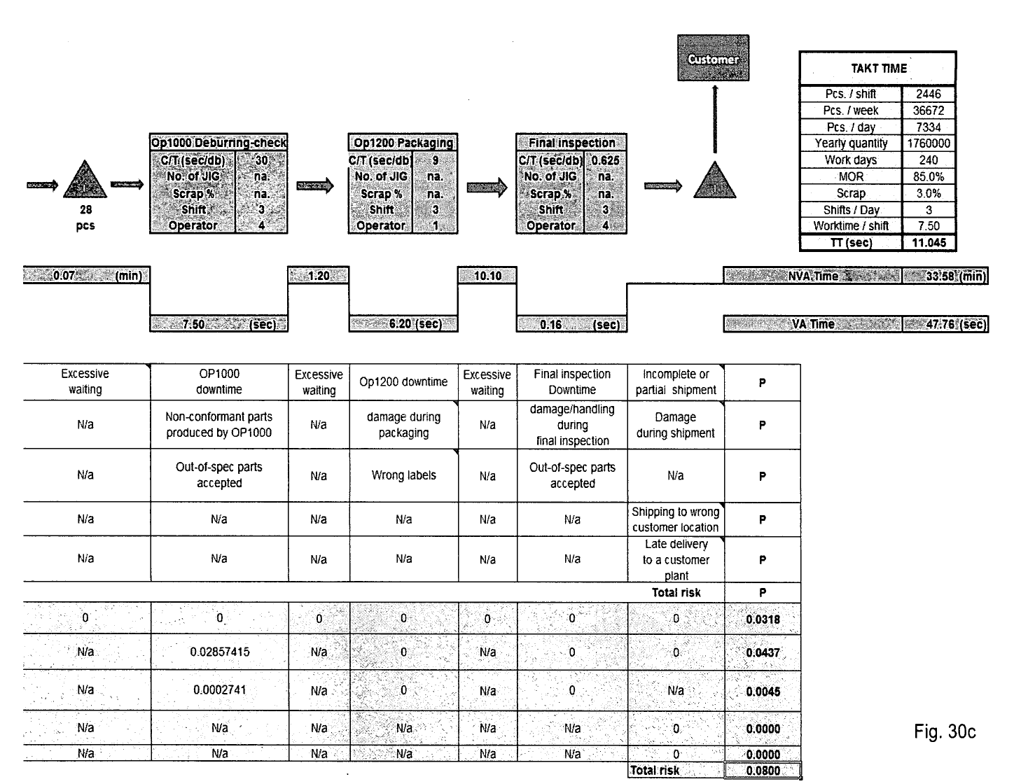

Stage 2, Step 8: Estimate individual risks of particular process operations: use historical data, audit results, and customer complaints data. Estimate overall risk for subgroups (Risk for Quantity, Risk for Quality and Risk for Delivery) as a sum of risks. The total estimated risk (as shown in lower right corner of FIG. 30) is 0.08 or 8%.

Stage 2, Steps 9 and 10: using the total estimated risk (0.08 or 8%), calculate the Actual Quantities.

Actual Quantity/shift=Ideal*(1−Total Risk)=3030*(1−0.08)=2788

Actual Quantity/year=Ideal*(1−Total Risk)=2181818*(1−0.08)=2007273

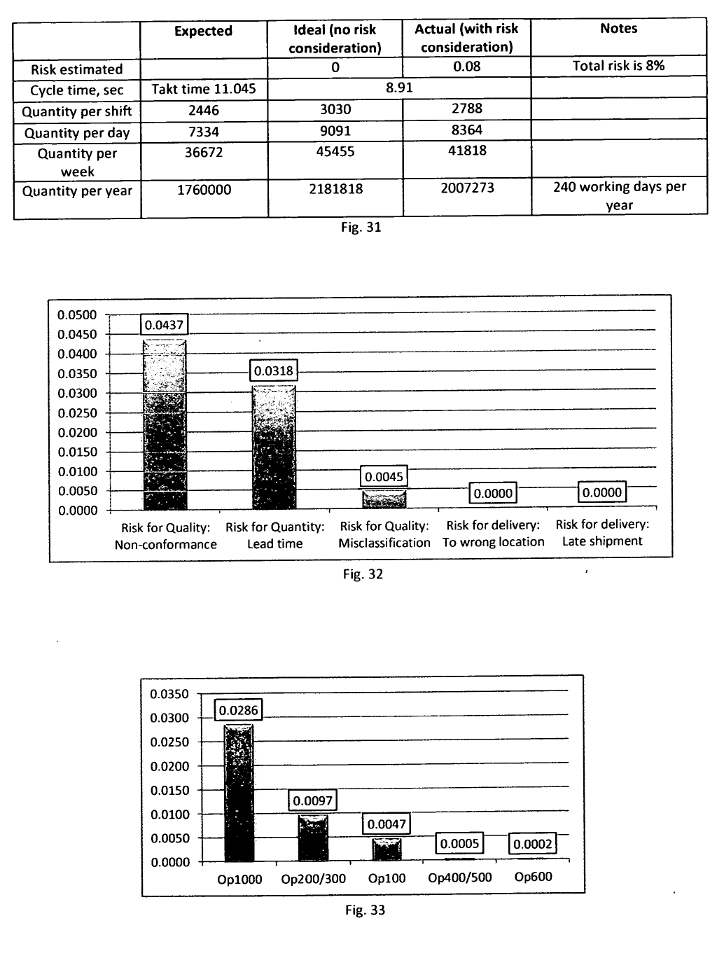

The results are tabulated in the table shown in FIG. 31.

The results from FIG. 31 show that such level of risk does not endanger the plant's commitment to meet the customer demand of 2446 parts/shift in production of parts; the process, with a risk of 8%, still has 13.9% reserve for customer demanded quantity, calculated as follows: ((2788−2446)/2446)*100=13.9%

Stage 3, Step 12: determine a subgroup of the biggest risk contribution (Risk for Quantity, Risk for Quality or Risk for Delivery) by using a Pareto chart. Total risk is 0.08 or 8.00%, and the biggest risk contributor is Risk for Quality/Non-conformance, at 0.0437 or 4.37%, as depicted in FIG. 32.

Stage 3, Step 13: Define the biggest risk contributor for this process (Quality/Non-conformance), by using the Pareto chart seen in FIG. 33.

Stage 3, Step 14: determine and implement an improvement action for the process to reduce the biggest risk. As depicted in FIG. 33, the biggest risk contributor is the process-operation Op1000, namely “Deburring-Visual check” and this high risk caused “Non-conformant parts produced”. The application of this method has helped identify which process operation contributes a high estimated risk value; this in turn allows prioritizing and implementing an appropriate improvement action.

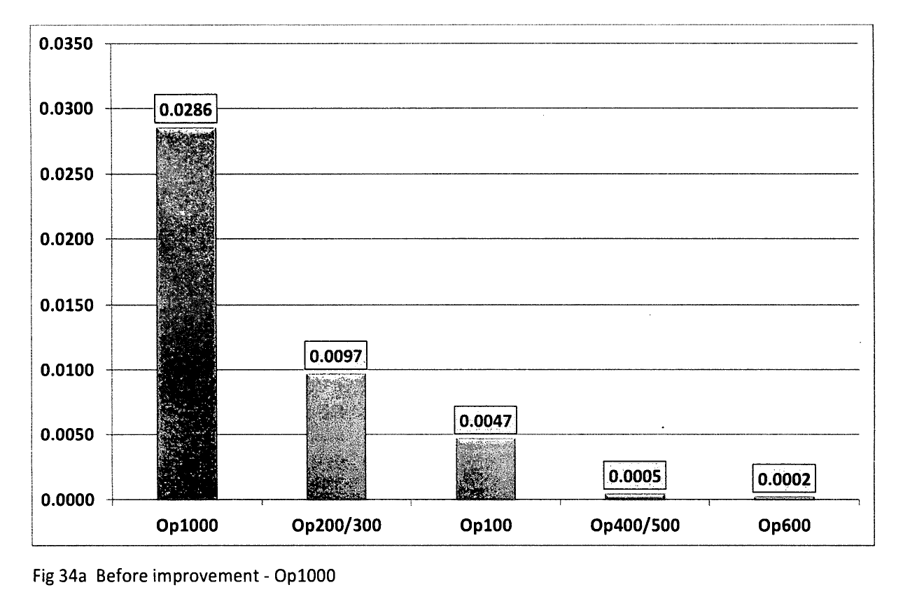

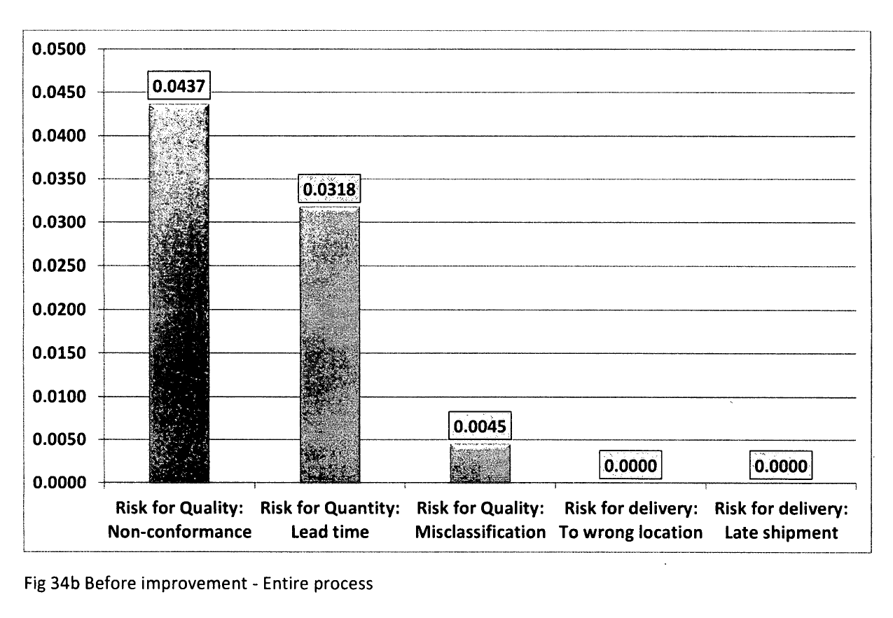

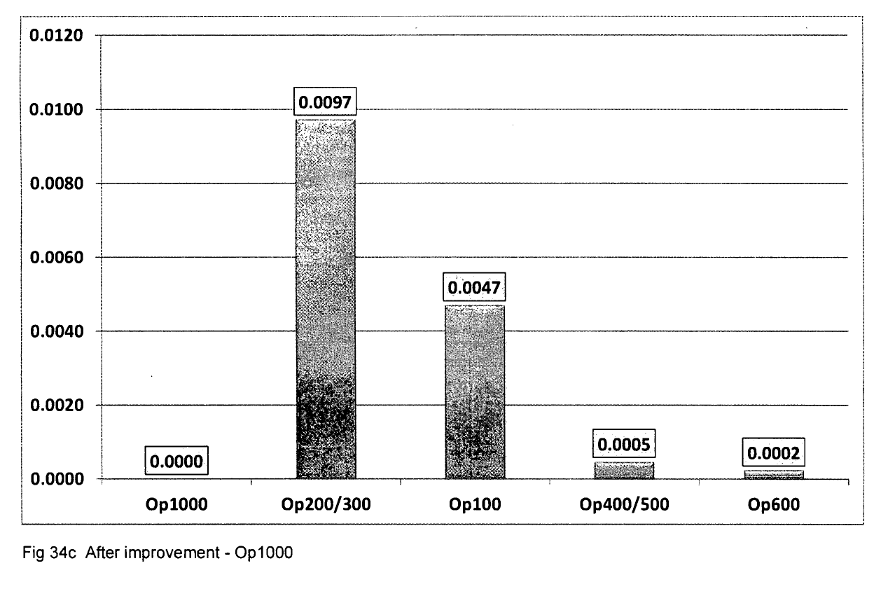

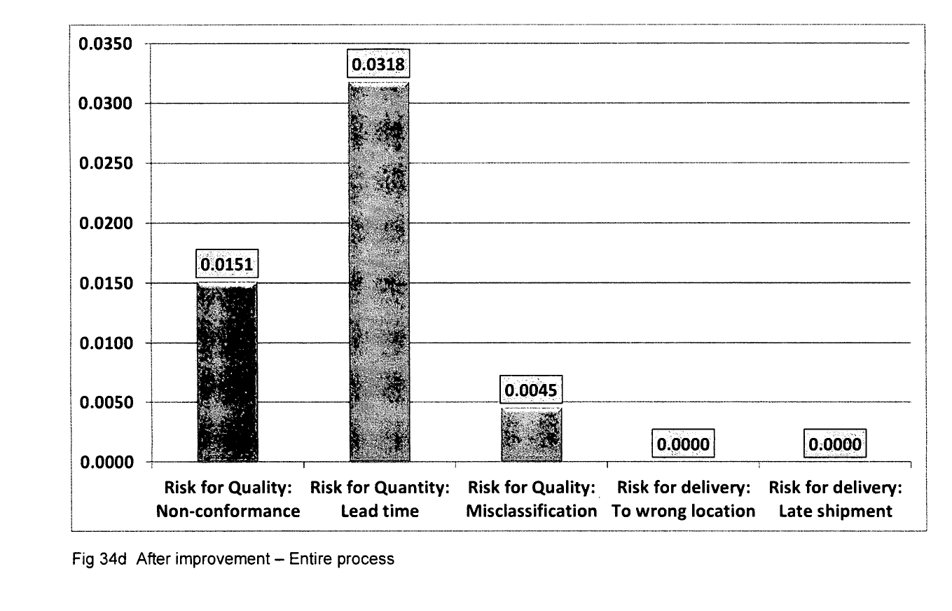

Steps 8-11 should be re-applied after each selection and upstream implementation of an improvement action. A new actual risk of Op1000 should then be estimated by new reject rate, and then an entire new risk matrix should be re-calculated. From the new risk matrix, the new biggest contributor to total risk is then selected as the next number 1 candidate for improvement. The Pareto graphs in FIG. 34 show the impact of the elimination of Risk contributed by Op1000 (Risk of non-conformant parts) on the entire process.

The improvement (lower risk) in Op1000 leads to the reduction of Risk for Quality, which in turn changes the balance of the entire process risk values; as a result, Risk for Quantity 0.0318 (or 3.18%) has now become the biggest risk contributor, as shown in FIG. 34.

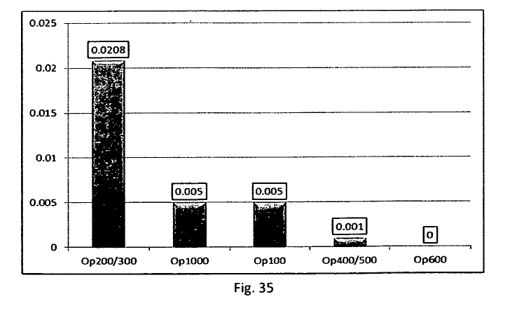

An answer to the question “which process operation generates the biggest risk now?” can be obtained from the new Pareto chart (depicted in FIG. 35), which shows the current biggest risk being 0.0208 (2.08%), associated with process-operation Op200/300. If this new 2.08% risk is still unacceptably large, the practitioners should now know to focus on improvement of machine availability and downtime reduction of Op200/300.

While the foregoing written description of the invention and exemplary embodiments enables one of ordinary skill to make and use what is considered presently to be the best mode thereof, those of ordinary skill will understand and appreciate the existence of variations, combinations, and equivalents of the specific embodiments, method, and examples herein. The invention should therefore not be limited by the above described embodiments, methods, and examples, but by all embodiments and methods within the scope and spirit of the invention.

### REFERENCES

1. AIAG (2008). Potential Failure Mode and Effect Analysis (FMEA), 4th Edition. Automotive Industry Action Group. ISBN 9781605341361.
2. Swann, C. D., & Preston, M. L., (1995) Journal of Loss Prevention in the Process Industries, vol. 8, no 6, pp. 349-353 “Twenty-five years of HAZOPs”
3. Yacov Y. Haimes Risk Modeling, Assessment, and Management, Wiley Series in System Engineering, 1998
4. Rother, Mike; Shook, John (2003). Learning to See: value-stream mapping to create value and eliminate muda. Brookline, Mass.: Lean Enterprise Institute. ISBN 0-9667843-0-8
5. Soundararajan Kannan; Yanzhen Li; Naveed Ahmed; Zeid El-Akkad, Developing a Maintenance Value Stream Map, Department of Industrial and Information Engineering, The University of Tennessee, Knoxville, Tenn. 37996-2210, 2007
6. Donatelli Anthony J., Harris Gregory A., Combining Value Stream Mapping and Discrete Event Simulation, University of Alabama in Huntsville, Huntsville, Ala. 35899, http://www.scs.org/confernc/hsc/hsc02/hsc/papers/hsc003.pdf

What is claimed is:

1. A method of evaluation and improvement for a process comprising one or more process operations, said method comprising the following steps:
development of a process map for said process;
estimation of value-adding and non-value adding process time attributes: cycle time, total time and lead time;
estimation of quantity of parts or service per unit of time by dividing total operation time over total cycle time;
making an assessment of meeting a customer's demand in quantity of parts or service;
revision of an entire process in case of not meeting customer demand in quantity per unit of time, in order to meet customer demand;
if meeting customer demand in quantity, deployment of a risk matrix for subgroups Quantity, Quality and Delivery, in order to take into account risks for Quantity, Quality and Delivery;
definition of individual risks for each process operation;
estimation of risk values for operations, subgroups Quantity, Quality and Delivery and total risk as a sum of risks of said subgroups;
adjustment of expected quantity of parts or service by an estimated total risk value, to obtain an adjusted quantity;
making an assessment of meeting an estimated total risk to acceptable value;
if said adjusted quantity does not meet customer demand, or if estimated risk of quality does not have an acceptable value, finding a first subgroup with a biggest risk contribution among Quantity, Quality and Delivery, by development of a first Pareto diagram among such subgroups;
Selection of a first process operation with a biggest risk sub-contribution within said first subgroup, by development of a second Pareto diagram within said first subgroup;
Selection of an improvement action for the first process operation, capable to reduce said biggest risk sub-contribution, followed by implementation of said improvement action;
Repeating one or more of previous steps until Quantity meets customer demand and total risk reaches an acceptable level, or until further improvement actions are not cost effective.

2. The method of claim 1, when implemented on a computer system.
